(19) United States
(12) Patent Application Publication
(10) Pub. No.: US 2007/0011338 A1
(43) Pub. Date: Jan. 11, 2007

(54) System and method for transparently processing multimedia data

(75) Inventors: Arnaud Glatron, Santa Clara, CA (US); Patrick Miauton, Mountain View, CA (US); John Bateman, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 11/241,312

(22) Filed: Sep. 29, 2005

Related U.S. Application Data
(60) Provisional application No. 60/688,838, filed on Jun. 8, 2005.

(51) Int. Cl. G06F 15/16

(52) U.S. Cl. 709/228

(57) ABSTRACT

A multimedia data processing system and method which transparently processes video and/or audio streams in real-time. The operation of a system in accordance with an embodiment of the present invention does not require any intervention from, or involvement of, either the producer of the video and/or audio stream, or the client application. With such a transparent solution, video and/or audio streams can be processed seamlessly, and completely independently of the specific client application that the user chooses to use. Thus a system in accordance with some embodiments of the present invention can be used with any client application of the user's choice. This allows the creation of a large number of video and/or audio effects and/or improvements to the benefit of the end-user.

### CROSS-REFERENCES TO RELATED APPLICATIONS

This application claims priority from provisional application No. 60/688,838, entitled “System and Method for Transparently Processing Multimedia Data”, filed on Jun. 8, 2005. Related applications of the same assignee are patent application Ser. No. 11/183,179, entitled “Facial Features-Localized and Global Real-Time Video Morphing”, filed on Jul. 14, 2005; and patent application Ser. No. 10/767,132, entitled “Use of Multimedia Data for Emoticons In Instant Messaging”, filed on Jan. 28, 2004, which are hereby incorporated herein in their entirety.

### STATEMENT AS TO RIGHTS TO INVENTIONS MADE UNDER FEDERALLY SPONSORED RESEARCH OR DEVELOPMENT

Not applicable

### REFERENCE TO A “SEQUENCE LISTING,” A TABLE, OR A COMPUTER PROGRAM LISTING APPENDIX SUBMITTED ON A COMPACT DISK.

Not applicable

### BACKGROUND OF THE INVENTION

1. Field of the Invention

The present invention relates in general to multimedia data processing, and specifically to a user mode multimedia processing layer for intelligently and transparently processing multimedia streams in real-time.

2. Background of Invention

Over the past few years, contact established by people with each other electronically has increased tremendously. Various modes of communication are used to electronically communicate with each other, such as emails, text messaging, etc. In particular, real-time video and audio communication (e.g., IM chats including video and/or audio) have become widely prevalent.

For purposes of video and audio real-time chats, cameras (often called webcams) are often connected to a user's computer, and the video and/or audio data captured by the camera is transmitted to the computer. Several options exist for the user to transmit still image, video and/or audio data, such as Instant Messaging (IM), live video streaming, video capture for purposes of creating movies, video surveillance, internet surveillance, internet webcams, etc. Various client applications are available on the market for such uses. For instance, for Instant Messaging alone, a user can choose from one of several applications, including MSN® Messenger from Microsoft Corporation (Redmond, Wash.), ICQ from ICQ, Inc., America OnLine Instant Messenger (AIM) from America Online, Inc. (Dulles, Va.), and Yahoo!® Instant Messenger from Yahoo! Inc. (Sunnyvale, Calif.).

Users often desire to alter the video and/or audio streams in certain ways. Such modifications may be desirable for various reasons. For instance, a user may want to look and/or sound like someone else (e.g., like some famous personality, some animated character, etc.). Another example is when a user simply wishes to be unrecognizable in order to maintain anonymity. Yet another example is when a user wants to look like a better version of himself (e.g., the user may not be dressed up for a business meeting, but he wants to project a professional persona). Still another example is when a user wants to create video/audio special effects. For these and various other reasons, users often wish to modify the video/audio stream actually captured by their webcam and/or microphone. In one example, users have an avatar which they choose. Published US application 20030043153 describes a system for modifying avatars.

Conventional video and audio processing systems are not capable of automatically and transparently performing the appropriate processing functions that may be required for such modification. Existing systems are largely non-transparent, requiring downstream applications to be configured in order to take advantage of video/audio modification capabilities. It is commonly the case that a processing component needs to be integrated into the client application in order to implement such modifications. These processing components are application specific. Alternately, a third-party component needs to be used to proactively add the processed output to the system stream. Yet another alternative is to introduce the video/audio modification capabilities in the driver for the multimedia data capturing device itself. However, the client application would still need to elect to have the effect applied, and the driver for each device would have to be customized to incorporate that functionality. Moreover, advanced processing is not possible in the driver because that environment lacks the proper services needed for such advanced processing. Further, anything in the driver is very static and requires a lot of testing to guarantee system stability, making it nearly impossible to provide a flexible and expandable architecture in the driver. In addition, if the processing functionality is in the driver, backward compatibility with existing devices and drivers cannot be achieved unless a new driver for the device is downloaded by the user.

What is needed is a system and method that can transparently modify still image, video and/or audio streams in real-time, independently of the specific client application that is used, and without needing to modify the device driver.

### BRIEF SUMMARY OF THE INVENTION

The present invention is a multimedia data processing system and method which transparently processes video and/or audio streams in real-time. The operation of a system in accordance with an embodiment of the present invention does not require any intervention from, or involvement of, either the producer of the video and/or audio stream, or the client application. With such a transparent solution, video and/or audio streams can be processed seamlessly, and completely independently of the specific client application that the user chooses to use. Thus a system in accordance with some embodiments of the present invention can be used with any client application of the user's choice. This allows the creation of a large number of video and/or audio effects and/or improvements to the benefit of the end-user.

In one embodiment, the processing of the multimedia data is performed by a User Mode Video Processing Layer (UMVPL) or a User Mode Audio Processing Layer (UMAPL). In one embodiment, the UMVPL or UMAPL is located on a multimedia data pathway between a multimedia source or sink and a client application. The Processing Layer is located in the user-mode, rather than in the kernel mode. The kernel is a very restrictive and touchy environment, and it lacks many of the services needed to apply advanced effects, especially for video. In addition it is easy to crash the system in the kernel; the user-mode environment is much safer. Furthermore, when in user-mode, the video and/or audio stream can be altered for each process. Thus the user can introduce a different set of effects for each individual process (application) or only choose to have effects in one process (application) while the other processes stay unaffected. Finally, the entrance to kernel mode for multimedia streams is very localized and thus it can be intercepted. When the code is in the kernel it becomes much harder to intercept.

In one embodiment, a system in accordance with an embodiment of the present invention includes a Process Creation Monitor, and an Injector Service, along with the UMVPL or UMAPL. The Process Creation Monitor monitors each process created, and notifies the Injector Service. This Injector Service then injects a library of injector hooks (Injector Hook DLL) into each process. These hooks, in turn, reroute each process via the UMVPL or UMAPL before the multimedia data reaches its destination.

In one embodiment, the source of the multimedia data could be the user's devices (such as a webcam, a microphone, etc.), and the destination could be the client application. In another embodiment, the direction of the multimedia data streaming could be from the client application to the user's devices (e.g., video output device (recording deck for example), speakers, etc.)

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and has not been selected to delineate or circumscribe the inventive subject matter.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a block diagram illustrating how a video/audio capturing device connected to a host may use a client application to communicate with another similar setup over a network

FIG. 2A illustrates one embodiment of one side of a system from FIG. 1.

FIG. 2B is a block diagram illustrating the data flow in a system described above with reference to FIG. 2A.

FIG. 3A is a block diagram illustrating a system in accordance with an embodiment of the present invention.

FIG. 3B is a block diagram illustrating the data flow in a system in accordance with an embodiment of the present invention.

FIGS. 4A, B & C are flowcharts depicting a specific example starting with opening a client application, then opening a video stream to closing the stream, in a system in accordance with an embodiment of the present invention.

FIG. 5 is a flowchart that identifies in general, the steps taken by the process creation monitor, the injector service, and the UMVPL in accordance with an embodiment of the present invention.

### DETAILED DESCRIPTION OF THE INVENTION

Reference will now be made in detail to several embodiments of the present invention. Although reference will be made primarily to implementation of a transparent video/audio processing system in a Windows environment for multimedia devices using the standard Windows Kernel Streaming protocol, one of skill in the art knows that the same concepts can be implemented in any of a variety of operating environments including a Linux, Mac OS, or other proprietary or open operating system platform including real-time operating systems. It should also be noted that while some embodiments are discussed in the context of video processing, these embodiments are also applicable to any type of multimedia processing (e.g., audio, still pictures, etc.). Further, it is to be noted that while some embodiments are discussed with the source of the multimedia being the user's device(s) and the sink being a client application, the data flow could be reversed in these embodiments.

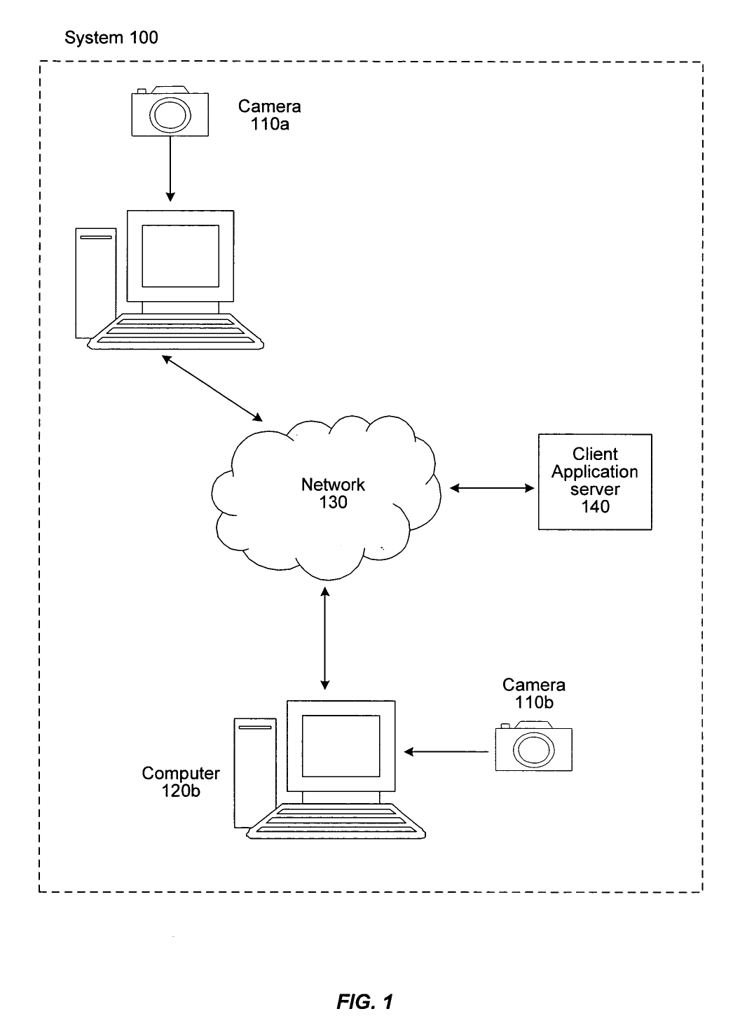

FIG. 1 is a block diagram illustrating how a video/audio capturing device connected to a host may use a client application to communicate with another similar setup over a network. Such a conventional system may be used by users to transmit multimedia information to each other. System 100 comprises data capture devices 110a and 110b, computer systems 120a and 120b, a network 130, and a client application server 140.

Data capture devices 110a and 110b can be any such devices connectable to computer systems 120a and 120b which can capture some type of multimedia data (e.g., video, audio, and/or still image). For instance, data capture devices 110a and 110b can be webcams, digital still cameras, microphones, etc. In one embodiment, the data capture devices 110a and/or 110b are QuickCam® webcams from Logitech, Inc. (Fremont, Calif.).

The hosts 120a and 120b are conventional computer systems, that may each include a computer, a storage device, a network services connection, and conventional input/output devices such as, a display, a mouse, a printer, and/or a keyboard, that may couple to a computer system. In one embodiment, the computer also includes a conventional operating system, an input/output device, and network services software. In addition, in one embodiment, the computer includes client application software which may communicate with the client application server 140. The network service connection includes those hardware and software components that allow for connecting to a conventional network service. For example, the network service connection may include a connection to a telecommunications line (e.g., a dial-up, digital subscriber line (“DSL”), a T1, or a T3 communication line). The host computer, the storage device, and the network services connection, may be available from, for example, IBM Corporation (Armonk, N.Y.), Sun Microsystems, Inc. (Palo Alto, Calif.), or Hewlett-Packard, Inc. (Palo Alto, Calif.).

The network 130 can be any network, such as a Wide Area Network (WAN) or a Local Area Network (LAN), or any other network. A WAN may include the Internet, the Internet 2, and the like. A LAN may include an Intranet, which may be a network based on, for example, TCP/IP belonging to an organization accessible only by the organization's members, employees, or others with authorization. A LAN may also be a network such as, for example, Netware™ from Novell Corporation (Provo, Utah) or Windows NT from Microsoft Corporation (Redmond, Wash.). The network 120 may also include commercially available subscription-based services such as, for example, AOL from America Online, Inc. (Dulles, Va.) or MSN from Microsoft Corporation (Redmond, Wash.).

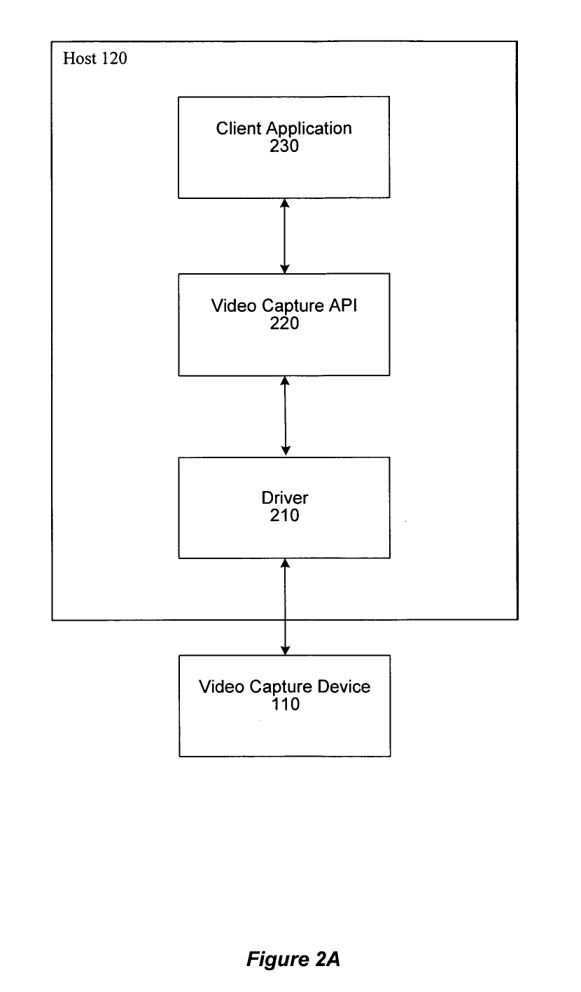

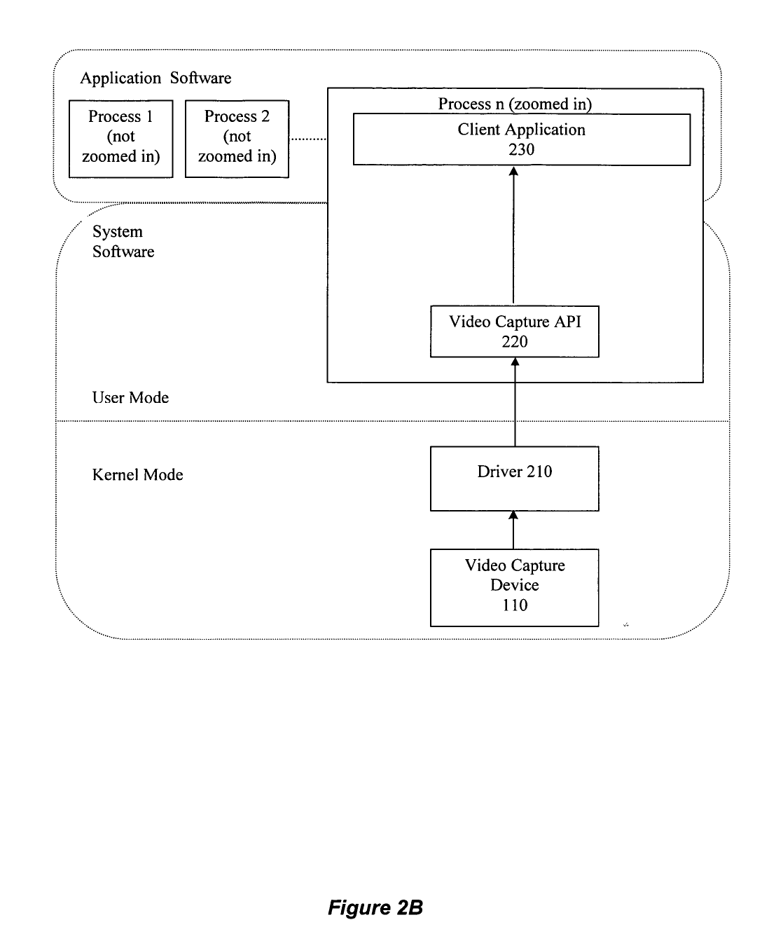

Some client applications require a client server 140. Client applications are discussed below with reference to FIG. 2A.

FIG. 2A illustrates one embodiment of one side of system 100 described above. As discussed above, this is comprised of a data capture device 110, and a host 120. For ease of discussion, the following discussion refers to capture and processing of video data. As mentioned above, it is to be noted that other types of multimedia data (e.g., audio and still image data) is also be processed in similar manners in various embodiments. In one embodiment, the driver 210 needed by the data capture device, a video capture Application Program Interface (API) 220, and the client application 230 which the user chooses to use, reside on the host 120.

The data capture device 110 and the host 120 have been described above with reference to FIG. 1. The driver 210 is a program that controls the data capture device 110. The driver 210 may come with the operating system on the host 120, or may need to be downloaded from the Internet, or from a CD accompanying the data capture device 110, etc. The driver 210 acts as a translator between the video capture device 110 and the operating system on the host 120. Each video capture device 110 has its own set of specialized commands that only its driver 210 knows. On the other hand, most operating systems access video capture device 110 by using generic commands. The driver 210 therefore needs to accept generic commands from the operating system on the host 120, and translate them into specialized commands that the video capture device 110 can understand. The driver 210 also acts an interface between the video capture device 110 and the video capture API 220 that uses the data capture device 110.

The video capture API 220 is a way of achieving abstraction between the driver 210 and the client application 230. In one embodiment, the video capture API 220 is DirectShow from Microsoft Corporation (Redmond, Wash.). In another embodiment, the video capture API 220 is Video for Windows (VFW) also from Microsoft Corporation (Redmond, Wash.). In yet another embodiment, the video capture API 220 is the Real-Time Communications (RTC) stack, from Microsoft Corporation (Redmond, Wash.).

The client application 230 can be any program which uses the video capture device 110. For instance, in one embodiment, the client application 230 is an Instant Messenger (IM). Some examples of currently available IM programs are MSN® Messenger from Microsoft Corporation (Redmond, Wash.), America OnLine Instant Messenger (AIM) from America Online, Inc. (Dulles, Va.), and Yahoo!® Instant Messenger from Yahoo! Inc. (Sunnyvale, Calif.). In another embodiment, the client application 230 is a Video Conferencing application, such as NetMeeting from Microsoft Corporation (Redmond, Wash.). In yet another embodiment, the client application 230 is an audio communication application, such as Skype from Skype Group (Luxembourg).

FIG. 2B is a block diagram illustrating the data flow in a system described above with reference to FIG. 2A. Different processes 1 through n are illustrated in FIG. 2B.

In the embodiment illustrated in this figure, video data is captured by the data capture device 110, passed on to the driver 210, on to the video capture API 220, and then passed on to the client application 230. It is to be noted, as mentioned above, that flow of data may also be in the reverse direction—that is, from the client application 230 to an output device (e.g., recording device attached to the host 120).

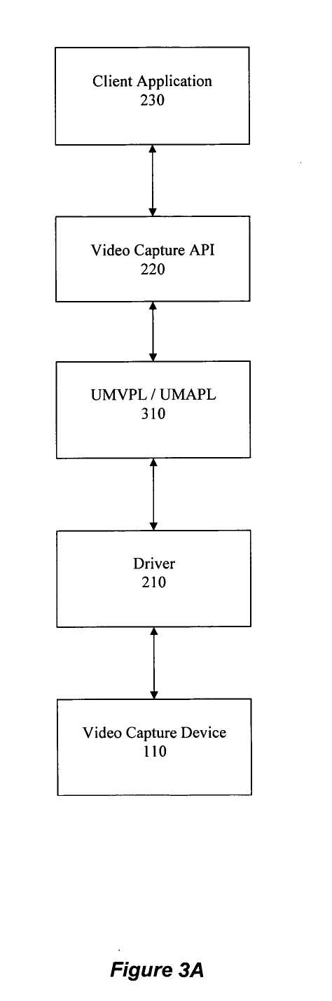

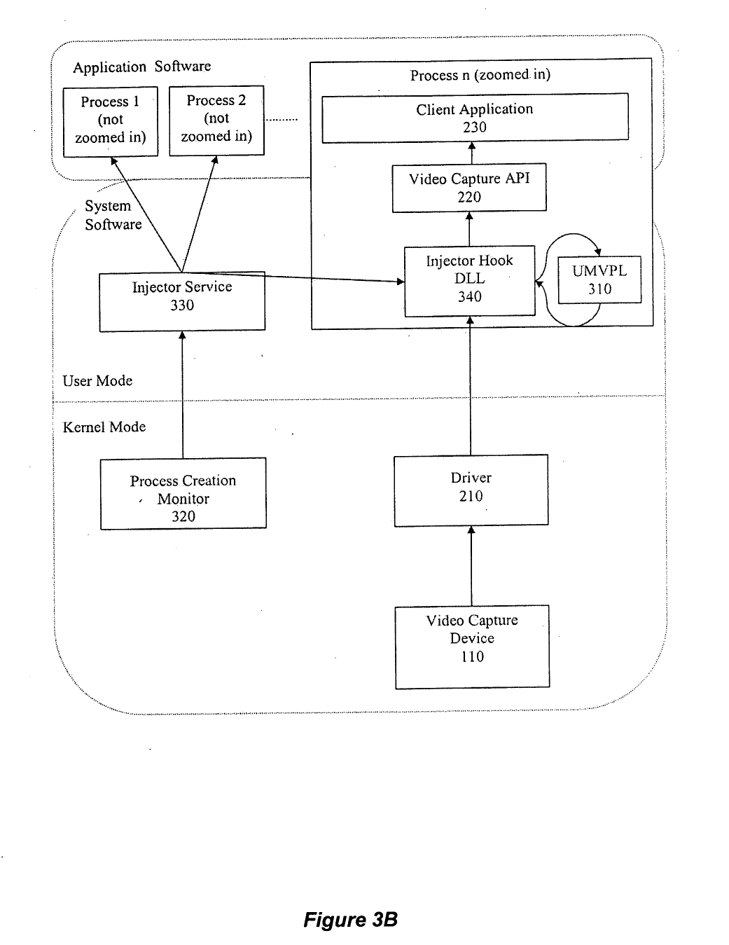

It can be seen that a distinction is drawn between the user mode and the kernel mode. These are discussed in more detail with reference to FIG. 3B.

FIG. 3A is a block diagram illustrating a system in accordance with an embodiment of the present invention. It is comprised of a video capture device 110, a driver 210, a User Mode Video Processing Layer (UMVPL) 310, a video capture API 220, and a client application 230.

The data capture device 110, the driver 210, the video capture API 220, and the client application 230 have been described above. By comparing FIG. 3A to FIG. 2A, it can be seen that the UMVPL 310 is a new layer. In one embodiment, the UMVPL 310 is inserted between the driver 210 and the client application 230. Positioned between the data source 110 and the client application 230, the UMVPL 310 is configured to transparently process the data streams. This allows the client application 230 to remain unaware of the original format/content of data streams from the data source 110. A system in accordance with an embodiment of the present invention can thus accept a variety of formats and content, and process and/or modify multimedia data as desired by the user.

It is to be noted that the discussion relating to the UMVPL 310 is also applicable to multimedia data other than video data. For instance, a User Mode Audio Processing Layer (UMAPL) will function very similarly, with modifications obvious to one skilled in the art.

In one embodiment where audio data is to be modified, the UMVPL 310 can be replaced by a UMAPL (User Mode Audio Processing Layer). In another embodiment, the UMVPL 310 can be supplemented by a UMAPL. The UMVPL/UMAPL is where the data stream is modified as desired by the user. This makes video/audio more attractive and more fun to use. For instance, the UMVPL 310 can perform color correction, image distortions and alterations, color keying, video avatars, face accessories, stream preview, spoofing, or any special effect desired affecting the video data stream (e.g., adding rain-drop effect) etc. The UMAPL can perform, for instance, channel mixing, silence buffer, noise suppression, noise cancellation and notch filtering, distortion, morphing, spoofing or any special effect desired affecting the audio data stream. In one embodiment, a user can enter his or her preferences for the types of processing to be performed on various types of streams, through a graphical user or other interface.

In one embodiment, an interface is defined to allow 3^{rd} parties to develop components or plug-ins for proprietary processing frameworks. In one embodiment, the 3^{rd} party implementations are independent from the platform on which they will run. In one embodiment, plug-ins can register one or more video and/or audio effects with the UMVPL 310. Thus the UMVPL 310 can be used to enable the concept of plug-ins to apply to transparent video and/or processing.

FIG. 3B is a block diagram illustrating the data flow in a system in accordance with an embodiment of the present invention. Apart from the components discussed above with respect to FIG. 2B, it includes a Process Creation Monitor 320, 330 an Injector Service, and an Injector Hook Dll 340.

As discussed with reference to FIG. 2B above, a video data stream is generated by the video capture device 110 in one embodiment, is processed, and is eventually output to the client application 230. More generally, a system in accordance with various embodiments of the present invention accepts a multimedia data stream from a source, processes the stream, and outputs the result to a data sink. Examples of sources of the multimedia data include peripheral devices such as microphones, stand-alone video cameras, webcams, microphones embedded in video cameras, audio sensors, and/or other video/audio capture devices. The data may also be provided by a client application 230 or converter. The data stream can comprise a file, and be provided from a portable storage medium such as a tape, disk, flash memory, or smart drive, CD-ROM, DVD, or other magnetic, optical, temporary computer, or semiconductor memory, and received over an analog 8 or 16 or more pin port or a parallel, USB, serial, firewire (IEEE 1394), or SCSI port. Or, it may be provided over a wireless connection by a Bluetooth™/IR receiver, Wireless USB, or various input/output interfaces provided on a standard or customized computer. The data stream may be dispatched to a data sink, such as a file, speaker, client application 230 or device (the same discussion about ports, storage and buses above applies for data sinks). The client application 230 can be any consumer that is a client to the source/sink 110. This could include a playback/recording application such as Windows Media Player from Microsoft Corporation (Redmond, Wash.), a communications application such as Windows Messenger from Microsoft Corporation (Redmond, Wash.), an audio editing application, a video editing application, or any other audio or other type of general or special purpose multimedia application. Client applications have also been discussed above in the context of FIG. 2A.

The data stream may be in any of a variety of formats. For instance, audio streams may be in a PCM or non-PCM format, wav format, mp3 format, compressed or uncompressed format, mono, stereo or multi-channel format, or 8-bit, 16-bit, or 24+ bit with a given set of sample rates. The data streams may be provided in analog form and pass through an analog to digital converter and may be stored on magnetic media or any other digital media storage, or can comprise digital signals. Video streams can also be compressed or uncompressed, and in any of a variety of formats including RGB, YUV, MJPEG, various MPEG formats (e.g., MPEG 1, MPEG 2, MPEG 4, MPEG 7, etc.), WMF (Windows Media Format), RM (Real Media), Quicktime, Shockwave and others. Finally, the data may also be in the AVI (Audio Video Interleave) format.

Referring again to FIG. 3B, when a client application 230 is opened, a process is created in the system. The Process Creation Monitor 320 monitors each process created, and notifies an Injector Service 330 whenever it detects the creation of a new process. This Injector Service 330 then injects a library of injector hooks (Injector Hook DLL 340) in this new process. In this manner, it is ensured that each process is injected with the Injector Hook DLL 340. These hooks, in turn, reroute each video data stream via the UMVPL 310 before the video data reaches its destination. In one embodiment, certain components are used by the Injector Hook DLL 340 to intercept the traffic between the driver 210 and the Video Capture API 220. In one embodiment, these components include KsUser.dll, Kernel32.dll, and NtDll.dll. KsUser.dll is the common library implementing the low level interface to the Windows Kernel Streaming components, Kernel32.dll is the common library implementing most of the low level Win32 functions and in particular the CreateFile( ) and DeviceIoControl( ) functions whch are intercepted in one embodiment. NtDll.dll is the common library which acts as a gateway to the kernel world in Windows. In one embodiment, the Injector Hook Dll 340 intercepts calls between KsUser.dll and NtDll.dll and between Kernel32.dll and NtDll.dll. This is how access is gained to the video data and requests to open and close devices/streams are detected.

In one embodiment, audio and video data is simultaneously provided. IN such an embodiment, the UMVPL 310 and the UMVPL are both present, and depending on the type of data, the data is routed to via the injector hooks to the UMAPL or the UMVPL 310. That is, the type of data is assessed, and audio data is routed to the UMAPL, and video data is routed to the UMVPL 310.

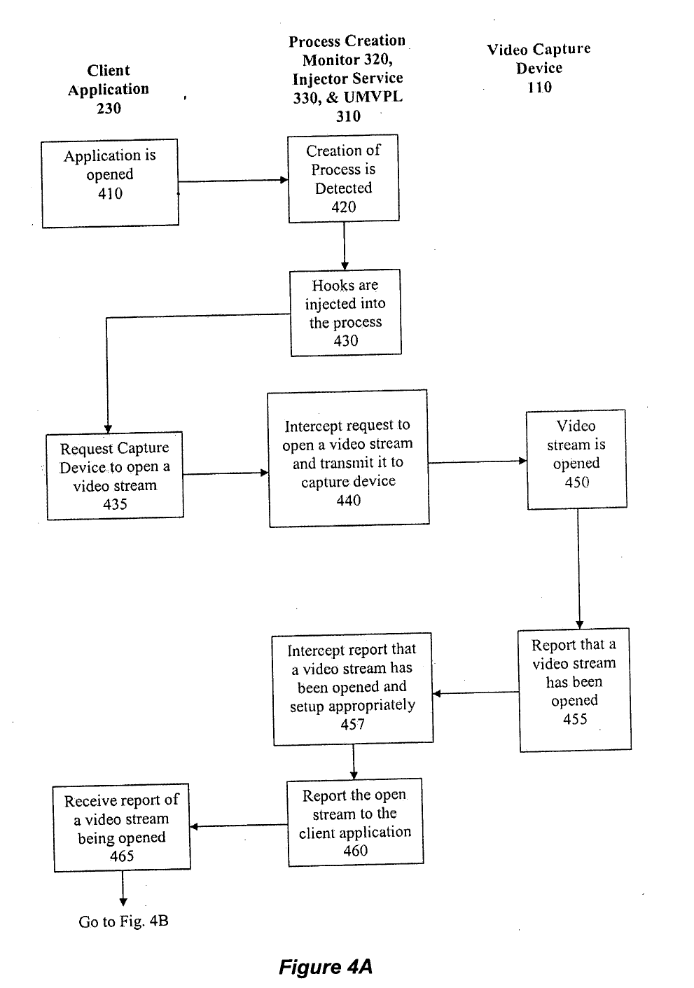

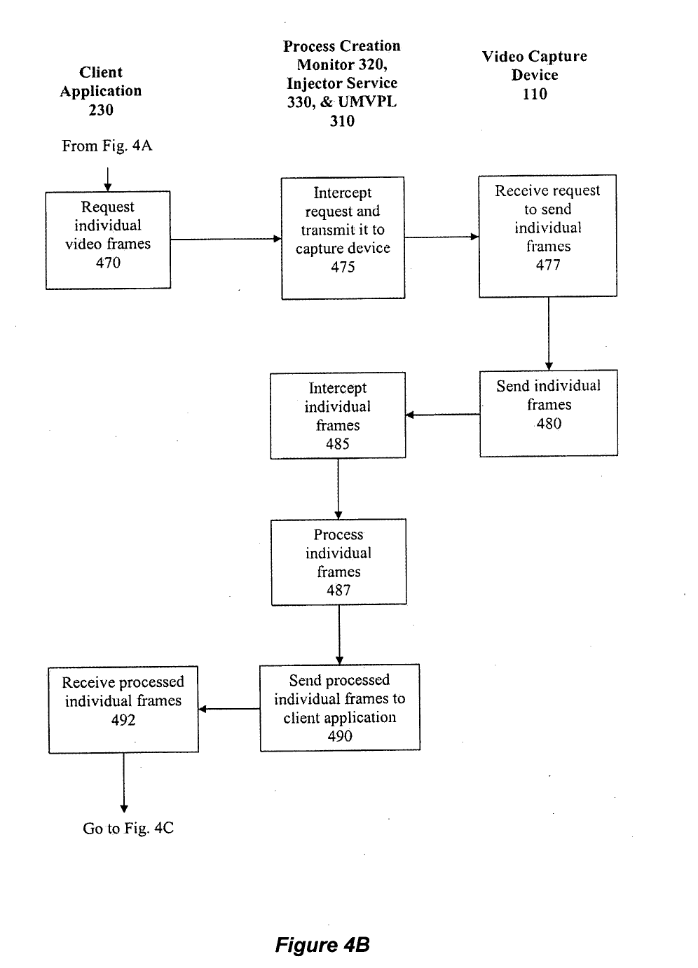

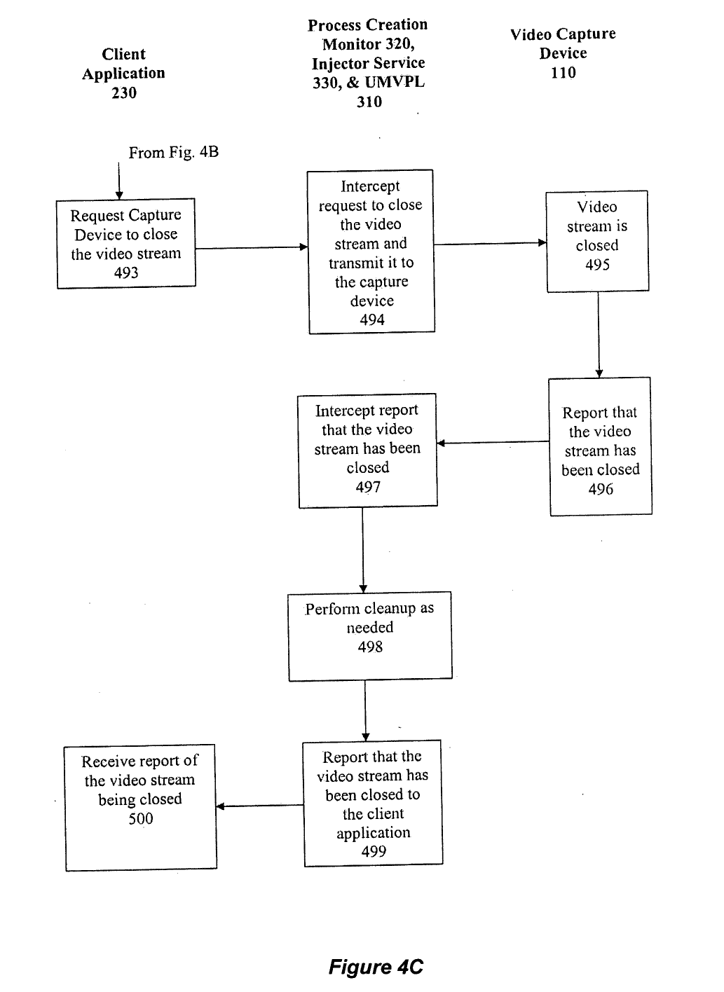

FIGS. 4A, B & C are flowcharts depicting a specific example starting with opening a client application 230, then opening a video stream to closing the stream, in a system in accordance with an embodiment of the present invention. The steps shown are taken by the client application 230, the Process Creation Monitor 320, the Injector Service 320, and the UMVPL 310, as well as the capture device 110.

As can be seen from FIG. 4A, when the client application 230 is opened (step 410), the creation of the process is detected (step 420) by the Process Creation Monitor 320. Hooks are then injected (step 430) into the process by the Injector Service 330. When the client application 230 requests (step 435) the capture device 110 to open a video stream, the UMVPL 310 intercepts this request and in turn transmits the request (step 440) to the capture device to open a video stream. The capture device 110 opens (450) the video stream. It also reports (step 455) that a video stream has been opened. This report is also intercepted (step 457), and appropriate setup is performed by the UMVPL 310. The UMVPL 310 then reports (step 460) the open stream to the client application 230. The client application thus receives (step 465) a report of the video stream being opened.

Referring now to FIG. 4B, it can be seen that the client application 230 now requests (step 470) individual video frames. Again, this request is intercepted (step 475) by the UMVPL, and then sent to the video capture device 110. When the video capture device receives (step 477) this request, it sends (step 480) individual video frames. These individual video frames are intercepted (step 485) by the UMVPL 310, and processed (step 487) by the UMVPL 310. Examples of such processing (step 487) have been provided above. These processed individual frames are then sent (step 490) to the client application 230. The client application receives (step 492) these processed frames.

Referring to FIG. 4C, it can be seen that the client application 230 requests (step 493) the capture device 110 to close the video stream. This request is again intercepted by the UMVPL 310 and transmitted (step 494) to the capture device 110. The video stream is then closed (step 495) by the video capture device 110, and it is reported (step 497) that the video stream has been closed. This report is intercepted (step 497) by the video stream, and cleanup is performed (step 498) as needed. Finally, it is reported (step 499) by the UMVPL 310 that the video stream has been closed, and the client application 230 receives (step 500) this report.

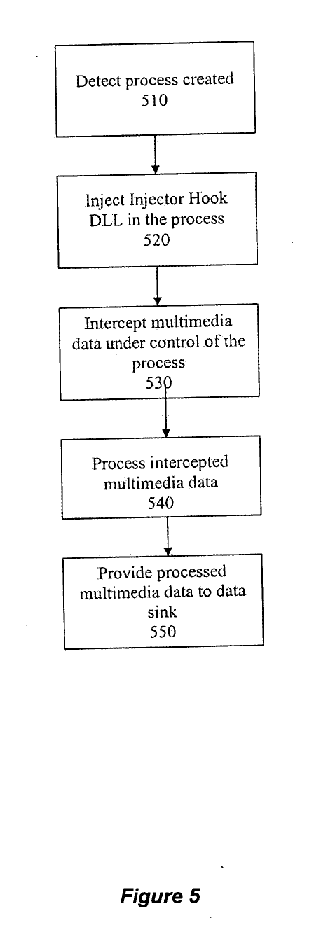

FIG. 5 is a flowchart that identifies in general, the steps taken by a system in accordance with an embodiment of the present invention for each process created. Any process created is detected (step 510) by the process creation monitor 320. Injector Hook DLL 340 is then injected (step 520) in the process by the Injector Service 330. The multimedia data under control of the process is then intercepted (step 530) by the UMVPL 310. These multimedia data is then processed (step 540) by the UMVPL 310. The processed multimedia data is then provided (step 550) to the data sink.

While particular embodiments and applications of the present invention have been illustrated and described, it is to be understood that the invention is not limited to the precise construction and components disclosed herein and that various modifications, changes, and variations which will be apparent to those skilled in the art may be made in the arrangement, operation and details of the method and apparatus of the present invention disclosed herein, without departing from the spirit and scope of the invention as defined in the following claims. For example, a system in accordance with the present invention could be used to manipulate/process still image media. Another example is that there could be more than one stream of multimedia data at any given time, with the different streams including different types of multimedia data (e.g., audio and video streams). In such a situation, two different processing layers (e.g., UMAPL and UMVPL) could be used simultaneously.

What is claimed is:

1. A system for transparently processing multimedia data, comprising:
a data source for providing multimedia data;
a data sink for receiving the multimedia data;
a process creation monitor for detecting each process created;
an injection service for injecting with at least one hook each process detected; and
a user mode processing layer to which the at least one hook redirects the multimedia data, and
wherein the multimedia data is transparently processed before it reaches the data sink.

2. The system of claim 1, wherein the multimedia data is video data.

3. The system of claim 2, wherein the data source is a webcam.

4. The system of claim 1, wherein the multimedia data is audio data.

5. The system of claim 4, wherein the data source is a microphone.

6. The system of claim 1, wherein the multimedia data is still image data.

7. The system of claim 1, wherein the data sink is a client application.

8. The system of claim 7, wherein the client application is an instant messaging application.

9. A system for transparently processing multimedia data, the system comprising:
a data source which provides the multimedia data;
a data sink which serves as the destination for the multimedia data;
a user mode processing layer communicatively coupled to the data sink and the data source, wherein the user mode processing layer is transparent to the data source and the data sink, and wherein the user mode processing layer intercepts the multimedia data before it reaches the data sink.

10. The system of claim 9, wherein the user mode processing layer modifies the multimedia data.

11. The system of claim 9, wherein the multimedia data is video data.

12. The system of claim 11, wherein the data source is a webcam.

13. The system of claim 9, wherein the multimedia data is audio data.

14. The system of claim 13, wherein the data source is a microphone.

15. The system of claim 9, wherein the data sink is a client application.

16. The system of claim 15, wherein the client application is an instant messaging application.

17. The system of claim 9, further comprising a driver for the data source.

18. The system of claim 9, further comprising a multimedia capture API for the data sink.

19. A system for transparently processing multimedia data, wherein the multimedia data is provided by a data source, and the multimedia data is received by a data sink, the system comprising:
a process creation monitor for monitoring each process;
an injection service for injecting with at least one hook each process detected; and
a user mode processing layer to which the at least one hook redirects the multimedia data, and wherein the multimedia data is processed before it reaches the data sink.

20. The system of claim 19, wherein the multimedia data is video data.

21. The system of claim 19, wherein the multimedia data is audio data.

22. The system of claim 19, wherein the multimedia data is still image data.

23. A method for processing multimedia data, wherein the multimedia data is provided by a data source, and the multimedia data is received by a data sink, where the processing is transparent to both the data source and the data sink, the method comprising:
detecting a process created in the system;
injecting at least one hook into the process;
routing, via the at least one hook, the multimedia data under control of the process to a processing layer;
processing the routed multimedia data in the processing layer,
providing the processed multimedia data to the data sink.

24. The method of claim 23, wherein the multimedia data is video data.

25. The method of claim 23, wherein the multimedia data is audio data.

26. The method of claim 23, wherein the multimedia data is still image data.
